(19) United States
(12) Patent Application Publication
(10) Pub. No.: US 2006/0149625 A1
(43) Pub. Date: Jul. 6, 2006

(54) Suggesting and/or providing targeting information for advertisements

(76) Inventor: Ross Koningstein, Menlo Park, CA (US)

Correspondence Address: STRAUB & POKOTYLO, 620 TINTON AVENUE, BLDG. B, 2ND FLOOR, TINTON FALLS, NJ, 07724, US

(21) Appl. No.: 11/026,508

(22) Filed: Dec. 30, 2004

(51) Int. Cl. G06Q 30/00

(52) U.S. Cl. 705/14

(57) ABSTRACT

The relevancy of ads may be increased, and opportunities to serve an ad that might otherwise be missed may be exploited by (i) accepting broad targeting information, to be used for serving an ad, from an advertiser, (ii) serving the ad using the broad targeting information, (iii) logging search query terms (or some other information, such as concepts, concept keywords, etc.) associated with the serving of the ad, and (iv) generating one or more candidate targeting keywords or phrases for the ad using the logged search query terms. At least one of the candidate targeting keywords or phrases may be provided as targeting information for the ad. Alternatively, at least one of the candidate targeting keywords or phrases may be presented to the advertiser. Advertiser input with respect to the candidate targeting keyword(s) or phrase(s) presented may then be accepted. Zero or more of the candidate targeting keyword(s) or phrase(s) may be provided as targeting information for the ad, in accordance with the accepted advertiser input. Cost information (e.g., average cost per selection, average cost per conversion, total costs, etc.) may be presented in association with the candidate targeting information.

### § 1. BACKGROUND OF THE INVENTION

§ 1.1 Field of the Invention

The present invention concerns advertising. In particular, the present invention concerns allowing advertisers to quickly implement an ad campaign and helping them to later refine (e.g., keyword) targeting used to serve ads.

§ 1.2 Background Information

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their ads to a receptive audience. That is, targeted ads are more likely to be useful to end users since the ads may be relevant to a need inferred from some user activity (e.g., relevant to a user's search query to a search engine, relevant to content in a document requested by the user, etc.) Query keyword targeting has been used by search engines to deliver relevant ads. For example, the AdWords advertising system by Google of Mountain View, Calif., delivers ads targeted to keywords from search queries. More specifically, the Google search engine Website allows advertisers to specify keywords for triggering the serving of an ad or a group of ads when those keywords, or some derivative thereof, are included in a search query. Similarly, content targeted ad delivery systems have been proposed. For example, U.S. patent application Ser. No. 10/314,427 (incorporated herein by reference and referred to as “the '427 application”) titled “METHODS AND APPARATUS FOR SERVING RELEVANT ADVERTISEMENTS”, filed on Dec. 6, 2002 and listing Jeffrey A. Dean, Georges R. Harik and Paul Buchheit as inventors; and Ser. No. 10/375,900 (incorporated by reference and referred to as “the '900 application”) titled “SERVING ADVERTISEMENTS BASED ON CONTENT,” filed on Feb. 26, 2003 and listing Darrell Anderson, Paul Buchheit, Alex Carobus, Claire Cui, Jeffrey A. Dean, Georges R. Harik, Deepak Jindal and Narayanan Shivakumar as inventors, describe methods and apparatus for serving ads relevant to the content of a document, such as a Web page for example. Content targeted ad delivery systems, such as the AdSense advertising system by Google for example, have been used to serve ads on Web pages.

Regardless of whether or how ads are targeted, an advertiser typically compensates the content (e.g., Web page) owner (and perhaps an ad serving entity). Such compensation may occur whenever the ad is served (per impression), or may be subject to a condition precedent such as a selection, a conversion, etc. Compensation per selection (commonly referred to as “pay per click”) is currently becoming popular.

One problem with targeted ad serving is that it can often be difficult for advertisers to specify appropriate keywords, or some other targeting criteria, for a given ad. Such poor targeting may lead to inappropriate ad serves (“over-serving”), or no ad serves when appropriate (“under-serving”). These problems are discussed in §§ 1.2.1.1 and 1.2.1.2 below. Moreover, the amount of work involved in determining appropriate targeting keywords may be so daunting to advertisers as to dissuade them from participating in such targeted ad serving systems.

### § 1.2.1 Over-Serving and Consequent Problems

In ad serving systems in which advertisers pay per selection, rather than per impression, most advertisers are not troubled if they get non-relevant impressions. After all, if users don't select the ads, the impressions are free. Indeed, ad impressions that don't lead to selections are a free way for an advertiser to build its brand. For example, the Website “Overture.com” hosts a so-called “search engine” service returning advertisements masquerading as “search results” in response to user queries. The Overture.com website permits advertisers to pay to position an ad for their Website (or a target Website) higher up on the list of purported search results. If schemes where the advertiser only pays if a user selects the ad (i.e., cost-per-click) are implemented, the advertiser lacks incentive to target their ads effectively, since a poorly targeted ad will not be selected and therefore will not require payment. Consequently, high cost-per-selection ads show up near or at the top, but do not necessarily translate into real revenue for the ad publisher because viewers don't select them. Furthermore, ads that users might otherwise select may be further down the list, or not on the list at all. Accordingly, such systems are certainly not good from the standpoint of users seeking relevant information, since their interests are subordinated to those of the advertisers. Moreover, since such systems employ a cost per click payment scheme rather than a cost per impression scheme, they are not particularly efficient from the standpoint of generating revenue for the ad server either.

Further, sometimes targeting criteria will trigger the serving of an ad at an inappropriate or undesirable time. For example, although a keyword targeting criteria (e.g., “travel”) of an ad (e.g., an ad for business travel) may literally match a term of a user's search query (e.g., “space travel”), serving the ad (e.g., an ad for business travel) might sometimes be inappropriate or undesirable. This could affect the performance of the ad. In some advertising systems, poor ad performance can result in increased costs and/or the ad being dropped. For example, some ad serving systems, such as Adwords Select from Google for example, may shut off low click-through targeting keywords for an ad, and use the performance of ads in serving decisions. In such systems, advertisers have a strong incentive to pick relevant keywords for their ads. As mentioned above, the amount of work involved in determining appropriate keywords may be daunting to advertisers and may dissuade them from participating in (or continuing to participate in) such systems.

Finally, if an advertiser does not use certain negative keyword targeting criteria, its ad may be served in instances where the ad isn't particularly relevant.

### § 1.2.2 Under-Serving and Consequent Problems

If an advertiser does not consider or use certain keyword targeting criteria for its ad, there could be a lost opportunity to serve an otherwise relevant ad for presentation to an end user. For example, an advertiser selling “Star Trek” DVDs may not think of using “Captain Kirk” as a targeting criteria, although such a query would likely be indicative of a user with an interest in “Star Trek” movies. This example illustrates problems associated with missed opportunities, where an ad isn't served when doing so would be appropriate or desirable.

From the perspective of the entity serving ads, missed opportunities to serve a relevant ad are lost opportunities to generate revenue. For example, with some ad serving systems, such as Adwords Select from Google for example, many search result pages served may contain no (or few) ads. If such opportunities to show an ad are missed, not only are they lost forever as a source of revenue, but nothing is learned about what ads could be shown for these searches, consequently forsaking future revenue.

From the perspective of an advertiser, not only does the advertiser miss an opportunity to present its ad to a good prospect, but if its ad were served pursuant to a match with a less popular keyword, the cost of such an ad serve may be less expensive than a more popular keyword with more competing advertisers.

### § 1.2.3 Selecting Effective Serving Criteria such as Keywords

As the sections on over-serving and under-serving above illustrate, poorly targeted ads are bad for users, advertisers, and ad serving systems. They also lead to inefficient pricing (e.g., not at market rates) for ad serving. For example, the pricing may be too high if the advertiser incorrectly associates value with a poor target. As another example, if a poor (or at least broad) target encompasses both good and bad ad serves, and an average bid may be too high for the bad ad serves, but too low for the good ad serves. As yet another example, pricing may be too low if valuable targeting information is not fully understood by all pertinent advertisers. Conversely, well targeted ads are relevant and therefore should perform well and enhance a user's experience and an ad server system's revenue. Unfortunately, it may be difficult for advertisers to learn how to pick good keyword targets.

Selecting good keyword targets is not always intuitive. Certain problems often occur repeatedly. For example, an advertiser may pick its own keywords, its ads may run for a brief time, and several keywords (or their whole campaign) may get shut off because of low performance (e.g., a low selection rate). Such advertisers may then request keywords, and recommendations (e.g., from customer service or from an automated keyword recommendation facility) may be provided to the advertiser. However, if the keyword recommendations aren't good, the ad can continue to perform poorly, and get shut off again. This learning process may become a source of advertiser frustration. Such frustration can lead to advertisers to stop using an ad serving system altogether, to reduce their use of an ad serving system, or not to expand their use of an ad serving system. Even if the advertiser perseveres, a process which slowly converges on a good keyword targeting slows the sales cycle.

Accordingly, it would be useful to improve the performance of online advertising. More specifically, it would be useful to increase the relevancy of ads, and to exploit opportunities to serve an ad that might otherwise be missed. Doing so should increase the revenue of an ad serving entity, improve the experience of users, and improve efficacy and cost (e.g., due to efficient market pricing) of advertiser's ads.

### § 2. SUMMARY OF THE INVENTION

The present invention may be used to increase the relevancy of ads, and to exploit opportunities to serve an ad that might otherwise be missed. At least one embodiment consistent with the present invention may do so by (i) accepting broad targeting information (and perhaps (e.g., uniform) offer information), to be used for serving an ad, from an advertiser, (ii) serving the ad using the broad targeting information, (iii) logging search query terms (or concepts, or concept keywords) associated with the serving of the ad, and (iv) generating one or more candidate targeting keywords or phrases for the ad using the logged search query terms.

In at least some embodiments consistent with the present invention, a uniform offer (e.g., bid) may be a single offer applied to a broad targeting criteria that may have narrower subsets. Thus, for example, a uniform offer may be used to cover related concepts with equivalent cost effectiveness.

At least one embodiment consistent with the present invention may provide at least one of the candidate targeting keywords or phrases as targeting information for the ad.

At least some embodiments consistent with the present invention may present at least one of the candidate targeting keywords or phrases to the advertiser, accept advertiser input with respect to the candidate targeting keyword(s) or phrase(s) presented, and associate zero or more of the candidate targeting keyword(s) or phrase(s) as targeting information for the ad, in accordance with the accepted advertiser input. In at least some embodiments consistent with the present invention, cost information (e.g., average cost per selection, average cost per conversion, total cost, etc.) may be presented in association with the candidates. Such embodiments may help advertisers to understand total costs and the sources of most of the total costs (in additional to helping advertisers understand the value of the candidates). Such embodiments may be used to help advertisers understand which narrower subsets of broad targeting (perhaps associated with an average cost bid) are more or less expensive. That is, by presenting such cost information to the advertiser, the advertiser can make a more informed decision about targeting criteria and their associated offers, thereby avoiding spending money on targeting criteria that doesn't work well for them.

### § 3. BRIEF DESCRIPTION OF THE DRAWINGS

FIG. 1 is a high-level diagram showing parties or entities that can interact with an advertising system.

FIG. 2 is a bubble chart of an exemplary advertising environment in which, or with which, the present invention may operate.

FIG. 3 is a flow diagram of an exemplary method for quickly establishing an ad campaign using broad keyword targeting, and then tuning the ad campaign, in manner consistent with the present invention.

FIG. 4 is a flow diagram of an exemplary method that may be used to allow an advertiser to setup an ad campaign quickly, and with little effort, in a manner consistent with the present invention.

FIG. 5 is a flow diagram of an exemplary method that may be used to suggest or provide keywords in a manner consistent with the present invention.

FIG. 6 is a flow diagram of an exemplary method that may be used to provide a user interface for presenting candidate keyword targeting information to an advertiser, and accepting advertiser feedback, in a manner consistent with the present invention.

FIG. 7 is a block diagram of an apparatus that may be used to perform at least some of the various operations, and store at least some of the various information, in a manner consistent with the present invention.

FIGS. 8-12 are diagrams and charts showing an example of operations in an exemplary embodiment consistent with the present invention.

### § 4. DETAILED DESCRIPTION

The present invention may involve novel methods, apparatus, message formats and/or data structures for helping advertisers by suggesting and/or providing keywords used to target ads (referred to as “targeting keywords”) and/or offer information. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventors regard their invention to include any patentable subject matter described.

In the following, definitions that may be used are provided in § 4.1. Then, environments in which, or with which, the present invention may operate are described in § 4.2. Then, exemplary embodiments of the present invention are described in § 4.3. Examples illustrating operations of exemplary embodiments of the present invention are described in § 4.4. Finally, some conclusions regarding the present invention are set forth in § 4.5.

### § 4.1 Definitions

Online ads may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a document on which, or with which, the ad was served, a search query or search results associated with the serving of the ad, a user characteristic (e.g., their geographic location, the language used by the user, the type of browser used, previous page views, previous behavior, user account, any Web cookies used by the system, etc.), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet another example, in some systems, an advertiser may specify that its ad is to be served only if a document being served includes certain topics or concepts, or falls under a particular cluster or clusters, or some other classification or classifications.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., clickthroughs) of an ad to the number of impressions of the ad (i.e., the number of times an ad is rendered) is defined as the “selection rate” (or “clickthrough rate”) of the ad. The selection rate of an ad rendered in an ad spot may be composed of various components such as a creative-specific selection rate (CSR), and a position-specific selection rate (PSR) for example. An estimated selection rate may be defined as the product of the component selection rates.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's Web page, and consummates a purchase there before leaving that Web page. Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions or selections of the ad (i.e., the number of times an ad is rendered or selected) is referred to as the “conversion rate.” If a conversion is defined to be able to occur within a predetermined time since the serving of an ad, one possible definition of the conversion rate might only consider ads that have been served more than the predetermined time in the past.

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as meta information, hyperlinks, etc.) and/or embedded instructions (such as JavaScript, etc.). In many cases, a document has a unique, addressable, storage location and can therefore be uniquely identified by this addressable location. A universal resource locator (URL) is an address that can be used to access information on the Internet.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer, Netscape, Opera), a media player (e.g., an MP3 player, a Realnetworks streaming audio or video file player, etc.), a viewer (e.g., an Abobe Acrobat pdf reader), etc.

A “content owner” is a person or entity that has some property right in the content of a document. A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary.

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

“Ad area” may be used to describe an area (e.g., spatial and/or temporal) of a document reserved or made available to accommodate the rendering of ads. For example, Web pages often allocate a number of spots where ads can be rendered, referred to as “ad spots”. As another example, an audio program may allocate “ad time slots”.

An “offer” is something presented for acceptance. In the context of the present invention, an offer will often be a monetary amount, associated with an advertisement, to be paid, upon the occurrence of an act with respect to the advertisement (e.g., impression, selection, conversion, etc.). An offer may be a bid. In some embodiments, rather than defining a precise value to be paid, an offer may specify a maximum and/or a minimum amount to be paid. An offer may be non-monetary.

An “arbitration” is a process for determining one or more winning participants competing for something. An auction is an example of an arbitration.

In targeted advertising, a “targeting keyword” may be an identified keyword or group of keywords (including phrases, or negative keywords), that target the serving of the ad by specifying (or restricting) when the ad is eligible to be shown. In some ad serving systems, an advertiser can specify how its keywords are to be used in ad serving decisions by specifying match types. For example, if an advertiser specifies a “broad” match type (which may be a default setting), the advertiser may include general keyword or keyword phrases (such as “tennis shoes” for example) in its keyword list. In this example, the advertiser's ads are eligible for serving when users search for “tennis” and “shoes,” in any order, and possibly along with other terms. The advertiser's ads might also be subject to expanded matches, including plurals and relevant variations.

Since other advertisers may be competing for the same broad-matched keyword combinations that trigger the serving of ads, using broad targeting keywords may increase cost amounts. Using exact, phrase, or negative matches (discussed below) can help advertisers minimize costs. An advertiser may specify a “phrase” match type (e.g., by entering their keyword in quotation marks, as in “tennis shoes”). In this case, its ad will be eligible for serving when a user searches on the phrase “tennis shoes,” in this order, and possibly with other terms in the query. For example, the advertiser's ad will be eligible for serving for the query “red tennis shoes” but not for “shoes for tennis.” Phrase matching is more targeted than broad matching, but slightly more flexible than exact matching.

An advertiser may specify an “exact” match type (e.g., by surrounding its keywords in brackets—such as [tennis shoes]). In this case, its ads will be eligible for serving when users search for the specific phrase “tennis shoes,” in this order, and without any other terms in the query. For example, the advertiser's ad won't be eligible for serving for the query “red tennis shoes.” An advertiser may also specify “negative” keywords. For example, if an advertiser's keyword is tennis shoes and it adds the negative keyword red, its ad will not be eligible for serving if a user searches on “red tennis shoes.” Naturally, other types of targeting keywords are possible.

### § 4.2 Environments in which, or with which, the Present Invention may Operate

### § 4.2.1 Exemplary Advertising Environment

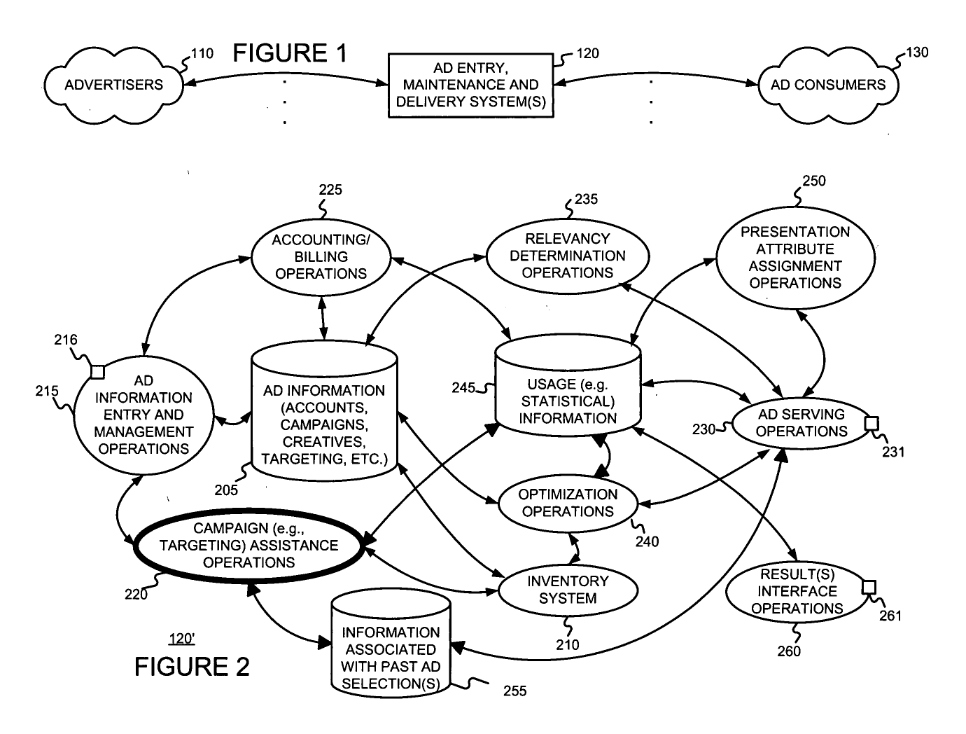

FIG. 1 is a high level diagram of an advertising environment. The environment may include an ad entry, maintenance and delivery system 120. Advertisers 110 may directly, or indirectly, enter, maintain, and track ad information in the system 120. The ads may be in the form of graphical ads such as so-called banner ads, text only ads, image ads, audio ads, video ads, ads combining one of more of any of such components, etc. The ads may also include embedded information, such as a link, and/or machine executable instructions. Ad consumers 130 may submit requests for ads to, accept ads responsive to their request from, and provide usage information to, the system 120. Although not shown, other entities may provide usage information (e.g., whether or not a conversion or selection related to the ad occurred) to the system 120. This usage information may include measured or observed user behavior related to ads that have been served.

One example of an ad consumer 130 is a general content server that receives requests for content (e.g., articles, discussion threads, music, video, graphics, search results, web page listings, etc.), and retrieves the requested content in response to, or otherwise services, the request. The content server may submit a request for ads to the system 120. Such an ad request may include a number of ads desired. The ad request may also include content request information. This information may include the content itself (e.g., page), a category corresponding to the content or the content request (e.g., arts, business, computers, arts-movies, arts-music, etc.), part or all of the content request, content age, content type (e.g., text, graphics, video, audio, mixed media, etc.), geolocation information, etc.

The content server may combine the requested content with one or more of the advertisements provided by the system 120. This combined information including the content and advertisement(s) is then forwarded towards the end user that requested the content, for presentation to the user. Finally, the content server may transmit information about the ads and how, when, and/or where the ads are to be rendered (e.g., position, click-through or not, impression time, impression date, size, conversion or not, etc.) back to the system 120. Alternatively, or in addition, such information may be provided back to the system 120 by some other means.

Another example of an ad consumer 130 is a search engine. A search engine may receive queries for search results. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference). Such search results may include, for example, lists of Web page titles, snippets of text extracted from those Web pages, and hypertext links to those Web pages, and may be grouped into a predetermined number of (e.g., ten) search results.

The search engine may submit a request for ads to the system 120. The request may include a number of ads desired. This number may depend on the search results, the amount of screen or page space occupied by the search results, the size and shape of the ads, etc. In one embodiment, the number of desired ads will be from one to ten, and preferably from three to five. The request for ads may also include the query (as entered or parsed), information based on the query (such as geolocation information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., WebPages), full text of identified documents, feature vectors of identified documents, etc.

The search engine may combine the search results with one or more of the advertisements provided by the system 120. This combined information including the search results and advertisement(s) is then forwarded towards the user that requested the content, for presentation to the user. Preferably, the search results are maintained as distinct from the ads, so as not to confuse the user between paid advertisements and presumably neutral search results.

Finally, the search engine may transmit information about the ad and when, where, and/or how the ad was to be rendered (e.g., position, click-through or not, impression time, impression date, size, conversion or not, etc.) back to the system 120. Alternatively, or in addition, such information may be provided back to the system 120 by some other means.

### § 4.2.2 Exemplary Ad Entry, Maintenance and Delivery Environment

FIG. 2 illustrates an exemplary ad system 120′ in which, or with which, the present invention may be used. The exemplary ad system 120′ may include an inventory system 210 and may store ad information 205 and usage information 245. The exemplary system 120′ may support ad information entry and management operations 215, campaign (e.g., targeting) assistance operations 220, accounting and billing operations 225, ad serving operations 230, relevancy determination operations 235, optimization operations 240, relative presentation attribute assignment (e.g., position ordering) operations 250, information associated with past ad selection operations 255, and result interface operations 260.

Advertisers 110 may interface with the system 120′ via the ad information entry and management operations 215 as indicated by interface 216. Ad consumers 130 may interface with the system 120′ via the ad serving operations 230 as indicated by interface 231. Ad consumers 130 and/or other entities (not shown) may also interface with the system 120′ via results interface operations 260 as indicated by interface 261.

An advertising program may include information concerning accounts, campaigns, creatives, targeting, etc. The term “account” relates to information for a given advertiser (e.g., a unique email address, a password, billing information, etc.). A “campaign” or “ad campaign” refers to one or more groups of one or more advertisements, and may include a start date, an end date, budget information, geo-targeting information, syndication information, etc. For example, Honda may have one advertising campaign for its automotive line, and a separate advertising campaign for its motorcycle line. The campaign for its automotive line have one or more ad groups, each containing one or more ads. Each ad group may include a set of keywords, and a maximum cost (cost per click-though, cost per conversion, etc.). Alternatively, or in addition, each ad group may include an average cost (e.g., average cost per click-through, average cost per conversion, etc.). Therefore, a single maximum cost and/or a single average cost may be associated with one or more keywords. As stated, each ad group may have one or more ads or “creatives” (That is, ad content that is ultimately rendered to an end user.). Naturally, the ad information 205 may include more or less information, and may be organized in a number of different ways.

The ad information 205 can be entered and managed via the ad information entry and management operations 215. Campaign (e.g., targeting) assistance operations 220 can be employed to help advertisers 110 generate effective ad campaigns. For example, the campaign assistance operations 220 can use information provided by the inventory system 210, which, in the context of advertising for use with a search engine, may track all possible ad impressions, ad impressions already reserved, and ad impressions available for given keywords. The ad serving operations 230 may service requests for ads from ad consumers 130. The ad serving operations 230 may use relevancy determination operations 235 to determine candidate ads for a given request. The ad serving operations 230 may then use optimization operations 240 to select a final set of one or more of the candidate ads. The ad serving operations 230 may then use relative presentation attribute assignment operations 250 to order the presentation of the ads to be returned. The accounting/billing operations 225 may be used to track charges related to the serving of advertisements and to bill advertisers. The information associated with past selections operations 255 may be used to track and store serving parameters such as information about search query terms, geography of searcher, time and date of the search, etc. Finally, the results interface operations 260 may be used to accept result information (from the ad consumers 130 or some other entity) about an ad actually served, such as whether or not click-through occurred, whether or not conversion occurred (e.g., whether the sale of an advertised item or service was initiated or consummated within a predetermined time from the rendering of the ad), etc. Such results information may be accepted at interface 261 and may include information to identify the ad and time the ad was served, as well as the associated result.

As will be appreciated from the description to follow, various aspects of the present invention may be applied to campaign targeting assistance operations 220.

Various exemplary embodiments of the present invention are now described in § 4.3.

### § 4.3 Exemplary Embodiments

As indicated above, embodiments consistent with the present invention may be used to tune broad keyword ad targeting used by an advertising system. Such embodiments may do so by presenting information to help advertisers understand (a) how to better target the serving of their ads, and/or (b) how to better spend or manage their ad budget. Advertisers can then take action using the understanding gleaned from such presented information. At least some embodiments consistent with the present invention may suggest and/or provide keywords (and/or concepts, concept keywords, keyword refinements, negative keywords, etc.) used to target ads. Alternatively, or in addition, such embodiments may present cost information (e.g., average cost per selection, average cost per conversion, total costs, etc.). Exemplary embodiments depicting the general operations of the advertising system are described in § 4.3.1 below. Exemplary embodiments for providing quick setup using broad keyword ad targeting are described in § 4.3.2. Then, exemplary embodiments for using such a tunable system to suggest and/or provide keywords is described in § 4.3.3. Some possible refinements and alternative embodiments are discussed in § 4.3.4. Finally, exemplary apparatus that may be used to perform various operations consistent with the present invention, and store various information consistent with the present invention are described in § 4.3.5.

### § 4.3.1 General Operation of Advertising System

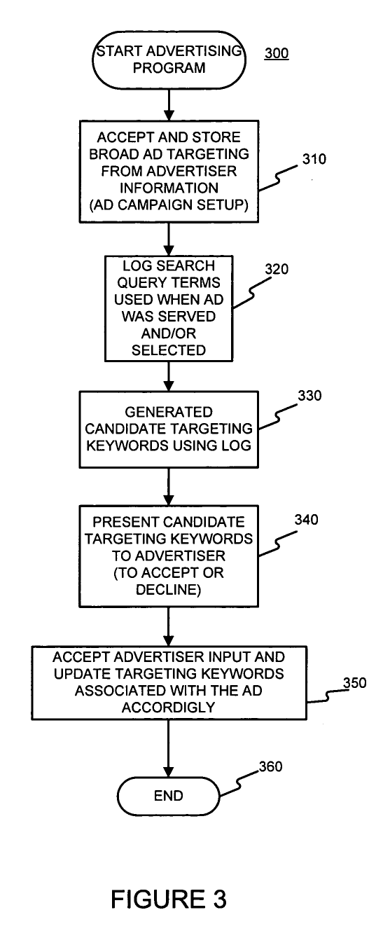

FIG. 3 is a flow diagram of an exemplary method 300 that may be performed to allow quick and easy ad campaign setup and to provide or suggest targeting keywords for tuning targeting consistent with the present invention. The advertising system accepts and stores broad targeting keyword information from the advertiser. (Block 310) The ad is served using such broad targeting. A log of search query terms used when the ad was served and/or selected is generated. (Block 320) Candidate keywords are then generated using the log. (Block 330) A list including suggested keywords (and negative keywords) may be presented to the advertiser. (Block 340) The advertiser may then determine whether to accept or decline the suggested keywords. The advertiser input is accepted and targeting keywords associated with the ad are updated accordingly. (Block 350) The advertising system can then use such updated targeting information in the future. Although not shown, at least some of the keywords may be automatically added to the ad campaign as targeting keywords.

### § 4.3.2 Automated Broad Targeting

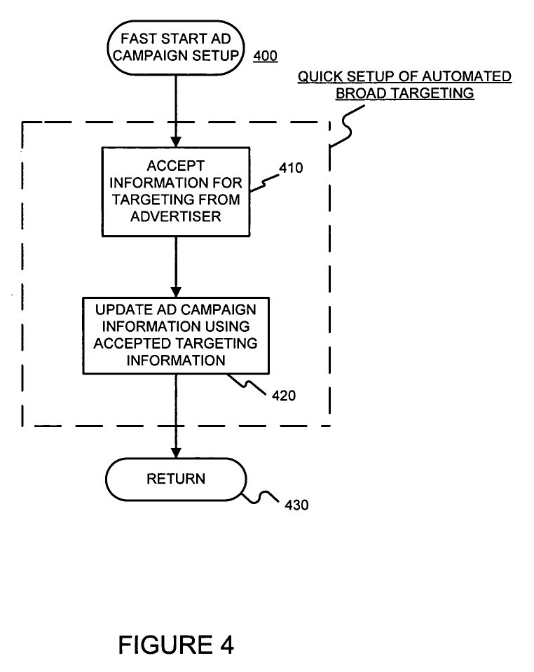

FIG. 4 is a flow diagram of an exemplary method 400 that may be used to allow an advertiser to setup an ad campaign quickly and with little effort, in a manner consistent with the present invention. In particular, to start the advertiser's ad campaign, the advertiser need only provide vague or limited information for targeting such as broad keyword targeting. The advertising system accepts the targeting information (Block 410) and updates the ad campaign information accordingly (Block 420) before the method 400 is left (Node 430).

At this point, the ad delivery system can automatically serve the ad using broad targeting. This quick method 300 benefits advertisers that don't want to invest a lot of time and effort to refine the targeting of its ads. However, as described below, embodiments consistent with the present invention allows the broad targeting to be tuned by using a lead discriminator for better utilization and better performance of an ad.

Referring back to block 410 of FIG. 4, the advertiser may simply enter broad targeting keywords. Alternatively, or in addition, the ad delivery system can extract such information from other ad information, such as the title line and/or creative text of a text ad, document information from an ad landing page (e.g., content, title, meta tags, etc.), etc.

### § 4.3.3 Keyword Suggestion/Provision

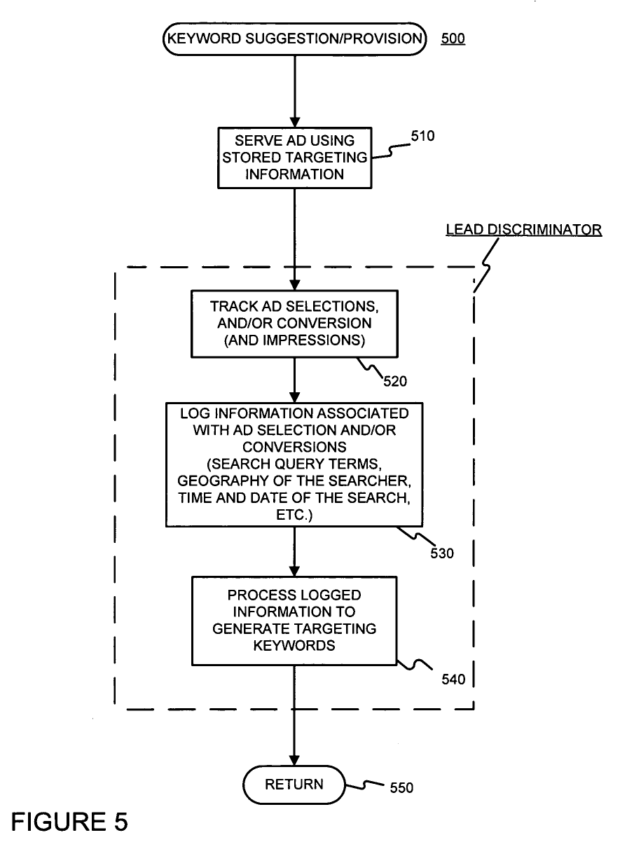

FIG. 5 is a flow diagram of an exemplary method 500 that may be used to perform, suggest, and/or provide keyword targeting information in a manner consistent with the present invention. Specifically, the ad is served using stored targeting information, as discussed above. (Block 510) When the ad is served, ad selections and/or conversions may be tracked (Block 520) and information associated with these events may be logged (Block 530). Ad impressions may also be tracked. The logged information is processed to generate a list with suggested keywords (Block 540) for presentation to the advertiser before the method 500 is left (Node 550). Alternatively, or in addition, at least some suggested keywords may be automatically added to the ad campaign as targeting keywords.

Referring back to block 530, information associated with ad selection and/or conversion (and perhaps impressions) may include one or more of search query terms, geographic location of the searcher, time and date of the search, etc. Such serving parameters may be stored by the ad delivery system.

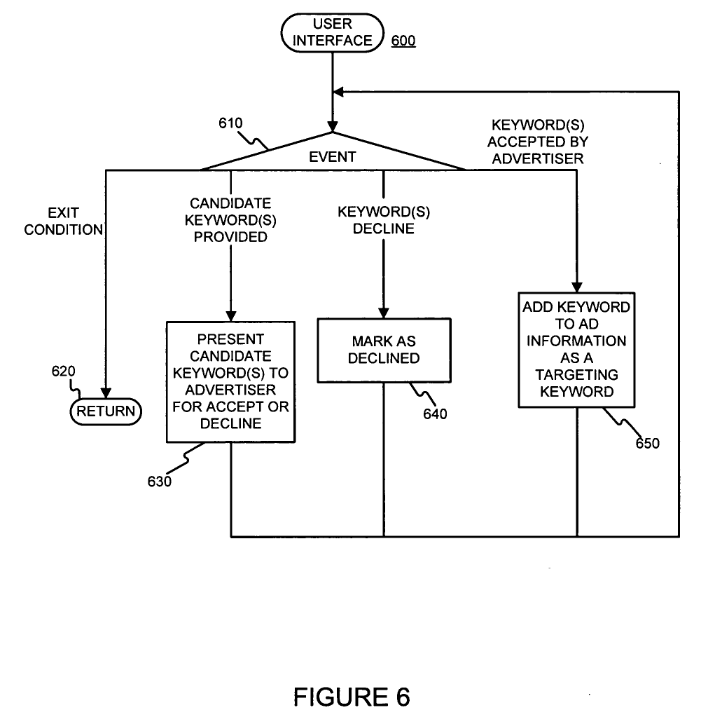

FIG. 6 is a flow diagram of an exemplary method 600 that may be used to provide a user interface for presenting candidate keyword targeting information to an advertiser, and accepting advertiser feedback, in a manner consistent with the present invention. As indicated by block 610, various branches of the method 600 may be performed in response to the occurrence of various different events. Specifically, if one or more candidate keywords are provided (e.g., by keyword suggestion operations), the candidate keyword(s) may be presented to the advertiser to accept or decline (Block 630) before the method 600 branches back to block 610. If one or more keywords are accepted by the advertiser, the keyword(s) may be added to ad information as a targeting keyword (Block 650) before the method 600 branches back to block 610. If one or more keyword(s) are declined by the advertiser, the keyword(s) may be marked as declined (Block 640) before the method 600 branches back to block 610. If an exit condition occurs, the method 600 may leave. (Node 620)

Referring back to block 630, the candidate keywords presented to the advertiser may be filtered to remove any targeting keywords already being used by the advertiser. Alternatively, or in addition, the candidate keywords presented to the advertiser may be filtered to remove any targeting keywords that the advertiser previously declined.

### § 4.3.4 Refinements and Alternatives

The suggested keywords may be any type of keyword, even including negative keywords for example. More broadly, embodiments consistent with the present invention may be used to provide other types of targeting information, such as concepts, concept keywords, etc.

### § 4.3.5 Exemplary Apparatus

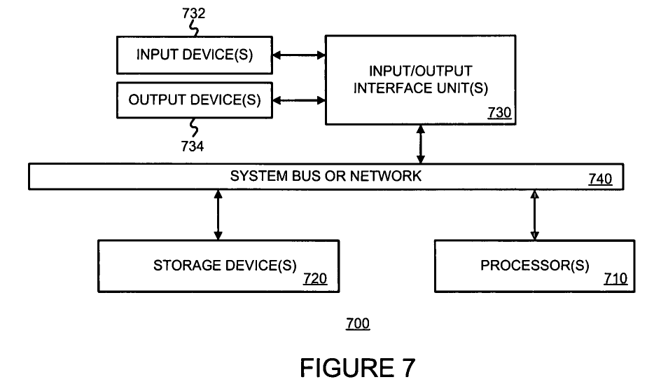

FIG. 7 is high-level block diagram of a machine 700 that may perform one or more of the operations and store various information discussed above. The machine 700 basically includes a processor(s) 710, an input/output interface unit(s) 730, a storage device(s) 720, and a system bus or network 740 for facilitating the communication of information among the coupled elements. An input device(s) 732 and an output device(s) 734 may be coupled with the input/output interface(s) 730.

The processor(s) 710 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to perform one or more aspects of the present invention. At least a portion of the machine executable instructions may be stored (temporarily or more permanently) on the storage device(s) 720 and/or may be received from an external source via an input interface unit 730.

In one embodiment, the machine 700 may be one or more conventional personal computers. In this case, the processing unit(s) 710 may be one or more microprocessors. The bus 740 may include a system bus. The storage devices 720 may include system memory, such as read only memory (ROM) and/or random access memory (RAM). The storage device(s) 720 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 732, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 710 through an appropriate interface 730 coupled to the system bus 740. The output device(s) 734 may include a monitor or other type of display device, which may also be connected to the system bus 740 via an appropriate interface. In addition to (or instead of) the monitor, the personal computer may include other (peripheral) output devices (not shown), such as speakers and printers for example.

### § 4.4 Examples of Operations

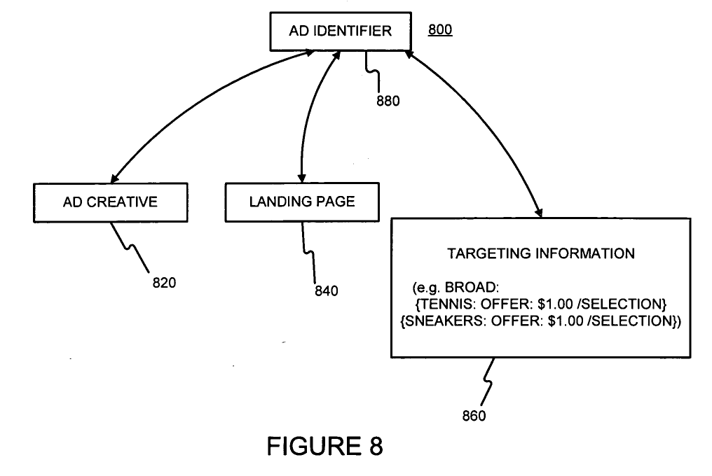

An example illustrating operations of an exemplary embodiment consistent with the present invention is now provided with reference to FIGS. 8-12. FIG. 8 illustrates exemplary information 800 of an ad campaign. As shown, this information may include an ad identifier 880 associated with an ad creative 820, a “landing page” 840, and targeting information 860. Suppose an advertiser is selling tennis sneakers. As shown in FIG. 8, when the advertiser inputs the keywords tennis and sneakers and associated offers, (and other pertinent ad information) for immediate serving of the ad, the targeting information 860 is populated with broad keywords for targeting.

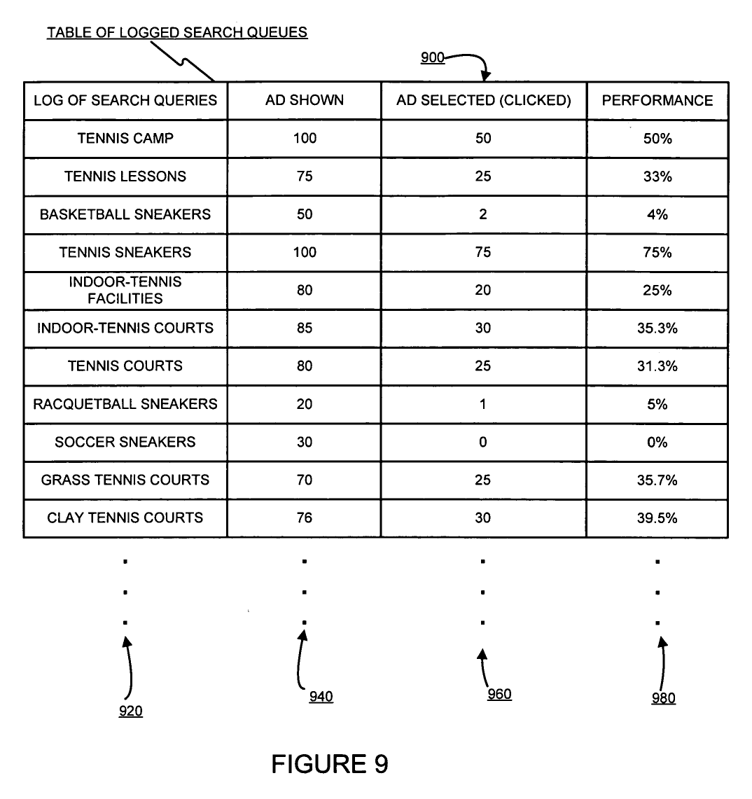

Once the ad campaign is started, the advertising system serves the ad using broad targeting keywords and a log of search queries and other useful statistical information (e.g., selections) is logged. FIG. 9 is an exemplary table 900 of logged impression and selection information for various search queries. The table 900 may include a number of entries. Each of the entries may include the search query 920, the number of times the ad was shown pursuant to the search query 940, the number of selections of the ad 960, and performance statistics 980, such as selection rate for example. In this example, the table 900 is sorted by the number of times the ad was shown.

Information from table 900 may be presented to the advertiser. Using such information, the advertiser can refine the targeting keywords used in serving its ad. For example, a column titled “add as a targeting keyword” may be provided. The advertiser may then select (e.g., by clicking or checking the appropriate entry of the column) which of the keywords it wishes to add. The system may then prompt the advertiser for an offer (e.g., a maximum offer per selection) to be associated with the new targeting keyword.

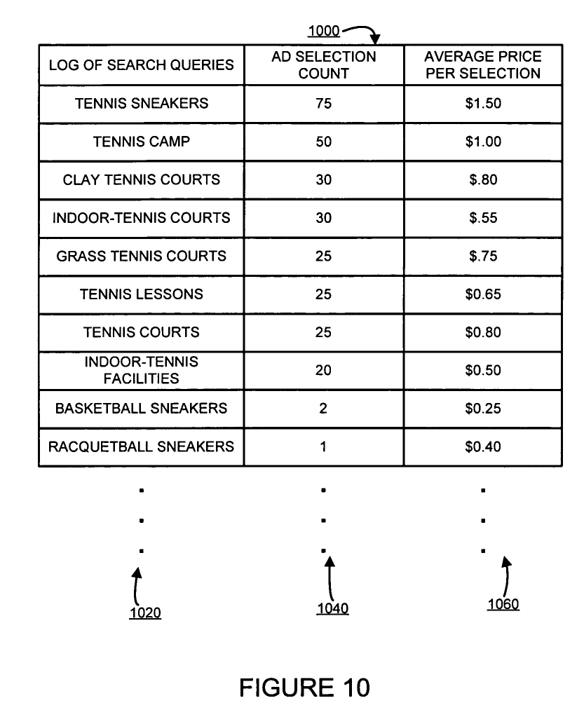

FIG. 10 is another exemplary table 1000 of logged search queries and associated information. The table 1000 may include a number of entries. Each of the entries may include the search query 1020, the number of selections of the ad 1040, and average price per selection of the ad for each search query 1060. In this example, the table 1000 is sorted by the number of times the ad was selected.

Information from table 1000 may be presented to the advertiser. Using such information, the advertiser can refine the targeting keywords used in serving its ad. For example, a column titled “add as a targeting keyword” may be provided. The advertiser may then select (e.g., by clicking or checking the appropriate entry of the column) which of the keywords it wishes to add. The system may then prompt the advertiser for an offer (e.g., a maximum offer per selection) to be associated with the new targeting keyword.

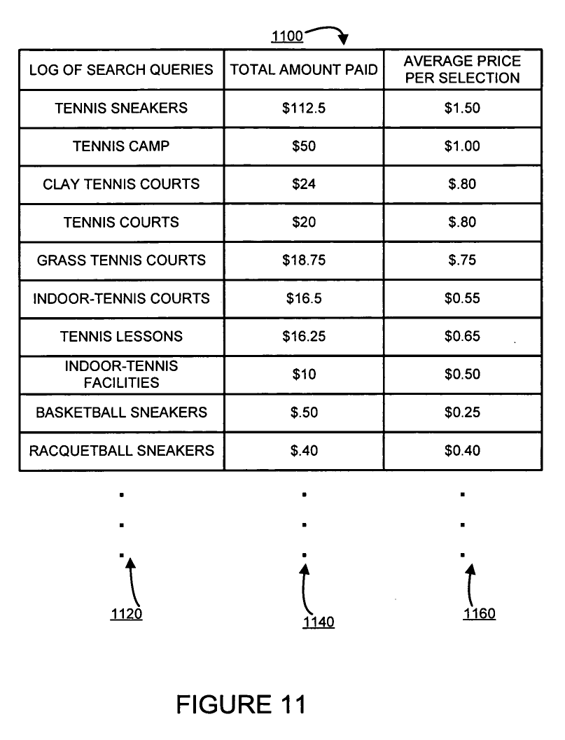

FIG. 11 is an exemplary table 1100 of logged total amount paid and average price per selection information for various logged search queries. The table 1100 may include a number of entries. Each of the entries may include the search query 1120, the total amount paid 1140 for the ad served when triggered the search query, and the average price per selection. As one skilled in the art will appreciate, this is a useful statistic since the advertiser can use it to determine how much of the advertiser's budget can be spent for particular targeting keywords. In this example, the table 1100 is sorted by the total amount paid. This is another useful information statistic since the advertiser can see which search query consumes most of the advertising budget and the average price per selection.

Information from table 1100 may be presented to the advertiser. Using such information, the advertiser can refine the targeting keywords used in serving its ad. For example, a column titled “add as a targeting keyword” may be provided. The advertiser may then select (e.g., by clicking or checking the appropriate entry of the column) which of the keywords it wishes to add. The system may then prompt the advertiser for an offer (e.g., a maximum offer per selection) to be associated with the new targeting keyword.

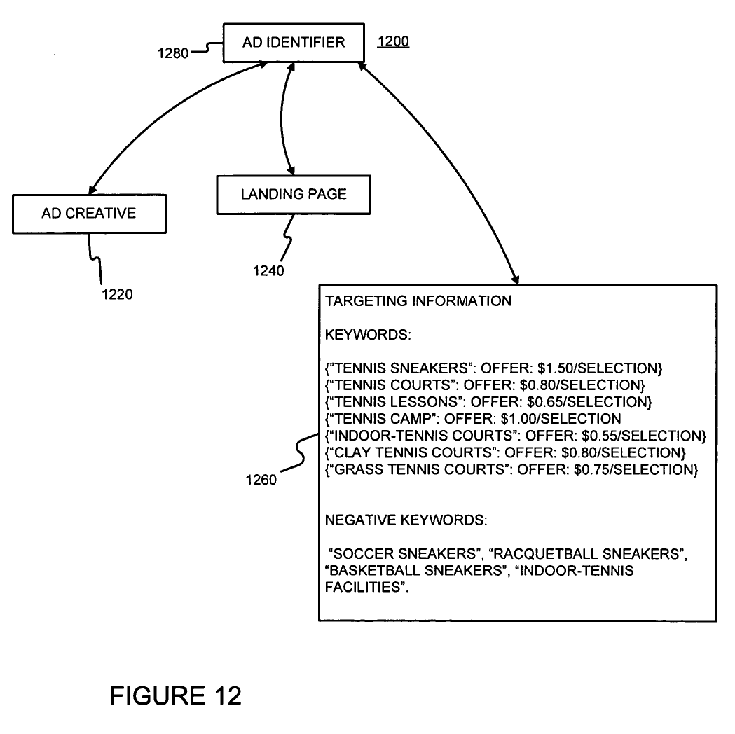

Some advertisers may consider selection count and the total amount of money spent per keyword to be important parameters for consideration in selecting suggested keywords. Therefore, as shown in FIG. 12, suppose that the advertiser selects at least some of the keywords from the lists, as well as negative keywords. Once the advertiser associates an offer with non-negative keywords, the new targeting information 1260 is stored. The advertiser may have provided some threshold for determining which keywords to add, or remove, or add as negative keywords. Now that the advertiser has inputted the new targeting information, its ad campaign should perform better.

Referring back to FIG. 9 and 540 of FIG. 5, the logged information can be processed in many ways using, for example, various statistical computations. For example, automated rollups can be used to combine information from similar search queries. Bi-gram (two words) rollups, for example, can be used since single words usually produce data that isn't good. For instance, in the example just described above with reference to FIG. 9, the bi-gram “tennis court” appears in four distinct search queries—“indoor tennis courts”, “tennis courts”, “grass tennis courts”, and “clay tennis courts”. The ad delivery system can combine (or “rollup”) data of these four queries under the bi-gram “tennis courts”. In this example, “tennis courts” would have 110 clicks, 311 impressions, 35.4% performance and cost $0.73 per click.

### § 4.5 Conclusions

As can be appreciated from the foregoing disclosure, the present invention can be used to help online advertisers and entities serving online ads by (i) allowing an advertiser to start an ad campaign with little time and effort, and (ii) allow such an advertiser to improve ad campaign over time by suggesting or providing targeting keywords to better target the ads and to exploit otherwise missed opportunities to serve relevant ads. The various techniques described above may be used in combination or in concert. Some embodiments of the present invention unburden advertisers of the need to learn the details of keyword targeting.

What is claimed is:

1. A computer-implemented method comprising:
a) accepting broad targeting information, to be used for serving an ad, from an advertiser;
b) serving the ad using the broad targeting information;
c) logging search query terms associated with the serving of the ad; and
d) generating one or more candidate targeting keywords or phrases for the ad using the logged search query terms.

2. The computer-implemented method of claim 1 further comprising:
e) providing at least one of the candidate targeting keywords or phrases as targeting information for the ad.

3. The computer-implemented method of claim 1 further comprising:
e) presenting at least one of the candidate targeting keywords or phrases to the advertiser;
f) accepting advertiser input with respect to the at least one candidate targeting keyword or phrase presented; and
g) associating zero or more of the candidate targeting keywords or phrases as targeting information for the ad, in accordance with the accepted advertiser input.

4. The computer-implemented method of claim 3 wherein the act of presenting at least one of the candidate targeting keywords or phrases presents each of the candidate targeting keywords or phrases in association with a corresponding ad impression count.

5. The computer-implemented method of claim 3 wherein the act of presenting at least one of the candidate targeting keywords or phrases presents each of the candidate targeting keywords or phrases in association with a corresponding ad selection count.

6. The computer-implemented method of claim 3 wherein the act of presenting at least one of the candidate targeting keywords or phrases presents each of the candidate targeting keywords or phrases in association with a corresponding ad conversion count.

7. The computer-implemented method of claim 3 wherein the act of presenting at least one of the candidate targeting keywords or phrases presents each of the candidate targeting keywords or phrases in association with a corresponding ad performance.

8. The computer-implemented method of claim 3 wherein the act of presenting at least one of the candidate targeting keywords or phrases presents each of the candidate targeting keywords or phrases in association with a corresponding average price per selection.

9. The computer-implemented method of claim 3 wherein the act of presenting at least one of the candidate targeting keywords or phrases presents each of the candidate targeting keywords or phrases in association with a corresponding average price per conversion.

10. The computer-implemented method of claim 3 wherein the act of presenting at least one of the candidate targeting keywords or phrases presents each of the candidate targeting keywords or phrases in association with a corresponding total amount to be paid for the ad.

11. The computer-implemented method of claim 3 wherein the act of presenting at least one of the candidate targeting keywords presents each of the candidate targeting keywords or phrases in association with a corresponding ad impression count, and wherein the candidate targeting keywords or phrases are presented in an order in accordance with the corresponding ad impression count.

12. The computer-implemented method of claim 3 wherein the act of presenting at least one of the candidate targeting keywords or phrases presents each of the candidate targeting keywords or phrases in association with a corresponding ad selection count, and wherein the candidate targeting keywords or phrases are presented in an order in accordance with the corresponding ad selection count.

13. The computer-implemented method of claim 3 wherein the act of presenting at least one of the candidate targeting keywords or phrases presents each of the candidate targeting keywords or phrases in association with a corresponding total amount to be paid for the ad, and wherein the candidate targeting keywords or phrases are presented in an order in accordance with the corresponding total amount to be paid.

14. The computer-implemented method of claim 1 wherein the act of accepting broad targeting information includes accepting broad targeting keywords from the advertiser.

15. The computer-implemented method of claim 1 wherein the act of accepting broad targeting information includes accepting an ad creative from the advertiser, and inferring broad targeting information from the ad creative.

16. The computer-implemented method of claim 1 wherein the act of accepting broad targeting information includes accepting ad landing page information from the advertiser, and inferring broad targeting information from the ad landing page.

17. The computer-implemented method of claim 1 further comprising:
associating ad serve parameters with the logged search query terms.

18. A computer-implemented method comprising:
a) accepting broad targeting information, to be used for serving an ad, from an advertiser;
b) serving the ad using the broad targeting information;
c) logging information associated with the serving of the ad; and
d) generating candidate targeting information for the ad using the logged information.

19. The computer-implemented method of claim 18 wherein the logged information includes concepts.

20. The computer-implemented method of claim 18 further comprising:
e) generating cost information using the logged information.

21. The computer-implemented method of claim 20 wherein the cost information is average cost per selection information associated with the candidate targeting information.

22. The computer-implemented method of claim 20 wherein the cost information is average cost per conversion information associated with the candidate targeting information.

23. The computer-implemented method of claim 20 wherein the cost information is a total cost associated with the candidate targeting information.

24. Apparatus comprising:
a) means for accepting broad targeting information, to be used for serving an ad, from an advertiser;
b) means for serving the ad using the broad targeting information;
c) means for logging search query terms associated with the serving of the ad; and
d) means for generating one or more candidate targeting keywords or phrases for the ad using the logged search query terms.

25. Apparatus comprising:
a) means for accepting broad targeting information, to be used for serving an ad, from an advertiser;
b) means for serving the ad using the broad targeting information;
c) means for logging information associated with the serving of the ad; and
d) means for generating candidate targeting information for the ad using the logged information.
